(19) United States
(12) Patent Application Publication
(10) Pub. No.: US 2006/0144032 A1
(43) Pub. Date: Jul. 6, 2006

(54) Rake with variable-length tines

(76) Inventor: David S. DeWinter, Luther, MI (US)

Correspondence Address: PRICE HENEVELD COOPER DEWITT & LITTON, LLP, 695 KENMOOR, S.E., P O BOX 2567, GRAND RAPIDS, MI, 49501, US

(21) Appl. No.: 11/322,726

(22) Filed: Dec. 30, 2005

Related U.S. Application Data
(60) Provisional application No. 60/640,827, filed on Dec. 30, 2004.

(51) Int. Cl. A01D 7/00

(52) U.S. Cl. 56/400.01

(57) ABSTRACT

A rake with variable-length tines includes an elongate shaft, a rake head fixed to one end of the elongate shaft, and an arcuate plate which includes a plurality of apertures, and is moveable between a retracted position in which the full length of the tines are exposed, and a deployed position in which the tine length is shortened, to accommodate various raking conditions. The arcuate plate includes a lateral flange that extends beyond the apertures, and along a plane generally parallel with the plane of the rake head.

### CROSS-REFERENCE TO RELATED APPLICATION

This application claims priority under 35 U.S.C. § 119(e) on U.S. Provisional Application No. 60/640,827, filed Dec. 30, 2004 by David S. DeWinter, entitled “RAKE WITH VARIABLE-LENGTH TINES” the entire disclosure of which is incorporated herein by reference.

### FIELD OF THE INVENTION

This invention relates to a rake with variable-length tines, which can be adjusted to accommodate various raking applications.

### BACKGROUND OF THE INVENTION

Over the years, various rakes have been developed to gather leaves, grass clippings, pulled weeds, and also light-weight litter, like the paper and plastic food containers and wrappings that often have to be cleaned up after outdoor concerts, festivals, picnics and other gatherings.

Although various long-tined rakes have been developed, some of them with adjustable-length tines, all of them lack the structural rigidity needed to effectively and efficiently clean the ground surface. For this reason there is a need for a better long-tined rake.

The following described invention addresses this need by providing a variable-length long-tined rake, which can be adjusted to more effectively clean the ground surface.

### SUMMARY OF THE INVENTION

The invention provides a long-tined rake, wherein the effective length of the tines can be easily changed to accommodate various raking needs or conditions. This is accomplished with a rake having an extendable plate slidably attached to the rake head for movement along the tines, and a lock for retaining the plate.

When extended from its normal (retracted) position, the plate shortens the effective (useable) length of the tines, and provides structural support to the rake head, particularly the unused portion of the tines. The plate structure may be curved to conform with a rake head having a curved shape.

These and other features, advantages and objects of the present invention will be further understood and appreciated by those skilled in the art by reference to the following specification, claims and appended drawings.

### BRIEF DESCRIPTION OF THE DRAWINGS

FIG. 1 is a top view of a rake in accordance with the invention.

FIG. 2 is a bottom view of a rake in accordance with the invention.

### DETAILED DESCRIPTION OF PREFERRED EMBODIMENT

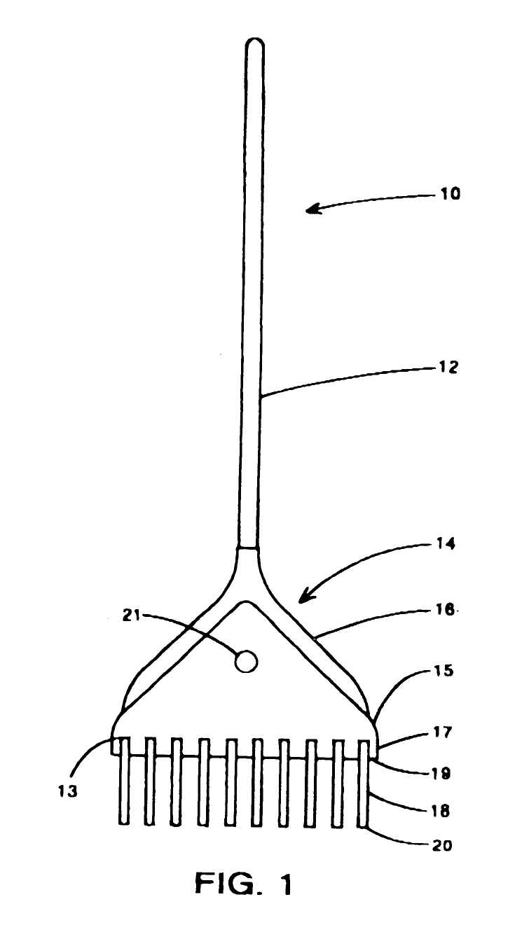

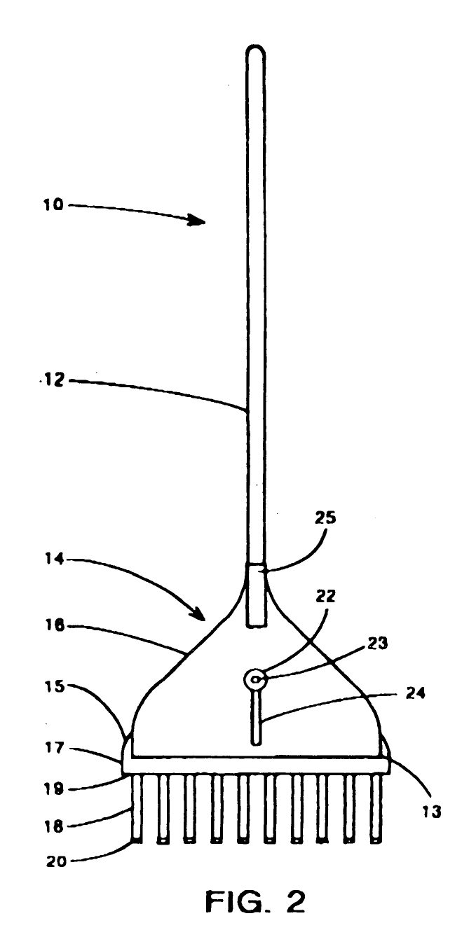

Shown in FIGS. 1 and 2 is a rake with variable-length tines 10 having an elongate shaft 12 connected to a rake head 14 via socket 25. Rake head 14 includes a plurality of tines 18 which project from upper portion 16 of rake head 14 and pass through apertures 13 in plate 15. The proximate end of plate 15 is fastened to rake head 14 via a locking mechanism comprised of a knob 21 fixed to a threaded stud 23 which passes through guide slot 24 in upper portion 16 of rake head 14, and engages a threaded retaining washer 22.

Plate 15 includes a flange 17 which projects beyond apertures 13 along a plane generally parallel with rake head 14. When plate 15 is extended and locked, the exposed length of the tines 18 is shortened and the tines 18 become stiffer. This allows more downward pressure to be applied to the rake 10, when the need arises. When plate 15 is fully extended, distal edge 19 of flange 17 is forced up against the underside of distal ends 20 of tines 18, and can project beyond the distal ends of tines 18. With this arrangement, any debris which may be lodged on the tines 18 may be scraped off.

The above description is considered that of the preferred embodiment only. Modifications of the invention will occur to those skilled in the art and to those who make or use the invention. Therefore, it is understood that the embodiment shown in the drawings and described above is merely for illustrative purposes and not intended to limit the scope of the invention, which is defined by the following claims as interpreted according to the principles of patent law, including the doctrine of equivalents.

The invention claimed is:

1. A rake with variable-length tines, comprising:
an elongate shaft;
a rake head including a plurality of parallel tines, the rake head being fixed at one end of the elongate shaft;
a plate slideably attached to the rake head, to allow linear movement of the plate with respect to the rake head; and
a lock for retaining the plate at or between a fully retracted position and/or a fully deployed position, to adjust the effective length of the tines.

2. The rake of claim 1, further comprising an actuator connected to the plate, whereby movement of the plate between the fully retracted position and the fully deployed position may be achieved by manipulation of the actuator.

3. The rake of claim 1, wherein the plate includes a plurality of apertures through which the tines project, to guide the plate during movement between the fully retracted position and the fully deployed position.

4. The rake of claim 1, wherein the lock also serves as the actuator.

5. The rake of claim 1, wherein the plate includes a lateral flange that extends beyond the apertures, and along a plane generally parallel with the plane of the rake head.

6. The rake of claim 1, wherein the plate and rake head have generally conforming curved shapes.
